(19) United States
(12) Patent Application Publication
(10) Pub. No.: US 2008/0017017 A1
(43) Pub. Date: Jan. 24, 2008

(54) Method and Apparatus for Melody Representation and Matching for Music Retrieval

(76) Inventor: Yongwei Zhu, Singapore (SG)

Correspondence Address: Blakely, Sokoloff, Taylor & Zafman, 12400 Wilshire Boulevard, 7th Floor, Los Angeles, CA, 90025, US

(21) Appl. No.: 10/580,305

(22) PCT Filed: Nov. 21, 2003
(86) PCT No.: PCT/SG03/00276

§ 371 Date: May 15, 2007

(51) Int. Cl. G10H 7/00

(52) U.S. Cl. 84/609

(57) ABSTRACT

This invention discloses a method for melody representation and matching able to accommodate pitch and speed variations in the query input The melody is represented by a sequence of data points, which is invariant to the speed or tempo of the melody. For the melody representation, the hummed query is converted to a pitch time series. The pitch time series is then approximated by a sequence of line segments. The line segment sequence in time domain is then mapped into a sequence of points in a value-run domain. The sequence of points is invariant to the time or speed in the original time series. In a data point sequence matching technique, the query data sequence is aligned with the target data sequence in a database. This alignment is done based on important anchor points in the data sequences that can tolerate value variation (pitch and key inaccuracy in the hummed query) and it also helps determine the probable matching candidates from all the subsequences of the target data sequences. The similarity between the query data sequence with the aligned candidate data subsequence is computed using a melodic similarity metric, which is based on melody aligning.

### FIELD OF THE INVENTION

The present invention relates to a method and apparatus for melody representation and matching for music retrieval and refers particularly, though not exclusively, to such a method and apparatus for content-based music retrieval and music retrieval by acoustic input. BACKGROUND TO THE INVENTION

Due to the increasing availability of digital music content, effective retrieval of relevant data is becoming very important. Query-by-humming is the most natural querying method for music retrieval since an average person can hum much better than they can play a musical instrument, or some other means. Also, when raising the query the relevant musical instrument may not be available. However a hummed melody can easily have tremendous variations in pitch and tempo. This poses a critical challenge for music retrieval by humming:
1. the hummed query may contain pitch inaccuracies;
2. the hummed query may be produced at an unknown or even inconsistent tempo (speed);
3. the hummed query may be anywhere in the target melody (not just the beginning);
4. the hummed query may be in a different key. For example, a female may use a high key, while a male may use a low key.

### SUMMARY OF THE INVENTION

This invention in one preferred aspect relates to a method for melody representation comprising the steps:
(a) converting a melody to a pitch-time series;
(b) approximating the pitch-time series to a sequence of line segments in a time domain; and
(c) mapping the sequence of line segments in time domain into a sequence of points in a value-run domain.

In a further preferred aspect the invention provides a method for creating a database of a plurality of melodies, the method comprising the steps, for each of the plurality of melodies:
(a) converting the melody to a pitch-time series;
(b) approximately the pitch-time series to a sequence of line segments in a time domain;
(c) mapping the sequence of line segments in time domain into a sequence of points in a value-run domain; and
(d) storing the sequence of points in the value run domain in the database.

In another preferred aspect, the invention provides a method for raising a query to compare an input melody With a plurality of melodies each stored in a database as a stored sequence of points in a value-run domain, the method comprising the steps:
(a) converting the input melody to a pitch-time series;
(b) approximating the pitch-time series to a sequence of line segments in a time domain;
(c) mapping the sequence of line segments in the time domain into a sequence of points in a value-run domain; and
(d) comparing the sequence of points in the value-run domain for the input melody with each of the stored sequence of points for each of the plurality of melodies to determine a stored melody of the plurality of melodies that matches the input melody.

For all aspects, the sequence of points in the value-run domain for the input melody may be used to create an input melody skeleton; the input melody skeleton preferably comprising extreme points in the sequence of points. The input melody may be input as an analog audio signal; and pitch values may be measured as relative pitch, in semitones.

In step (a), a non-pitch part may be replaced by an immediately previous pitch value.

The result of step (c) may be invariant to a tempo of the melody.

Comparing may be by sequentially comparing the melody skeleton with the stored melody skeleton until a match is found. Preferably, non-extreme points in the sequence of points are not considered in the matching process.

In yet another preferred aspect of the invention there is provided apparatus for enabling the raising of an input melody query of a plurality of stored data point sequences melodies in a database, the apparatus comprising;
(a) a microphone for creating an input analog audio signal of the input melody;
(b) a pitch detecting a tracking module for determining pitch values in the input analog audio signal and generating a pitch value time series;
(c) a line segment approximation module for approximating the pitch value time series to a line segment series;
(d) a mapping module for mapping line segment series to a data point sequence; and
(e) a melody search engine to perform a melody similarity matching procedure between the input melody data point sequence and each of the plurality of stored data point sequences in the database.

In a penultimate preferred aspect of the invention there is provided a computer usable medium comprising a computer program code that is configured to cause at least one processor to execute one or more functions for raising a query to compare an input melody with a plurality of melodies each stored in a database as a stored sequence of points in a value-run domain, by:
(a) converting the input melody to a pitch-time series;
(b) approximating the pitch-time series to a sequence of line segments in a time domain;
(c) mapping the sequence of line segments in the time domain into a sequence of points in a value-run domain; and
(d) comparing the sequence of points in the value-run domain for the input melody with each of the sequence of, points in he value run domain of the plurality of melodies to determine a stored melody of the plurality of melodies that matches the input melody.

A final aspect of the invention provides method for raising a query to compare an input melody with a plurality of melodies each stored in a database and stored as a melody skeleton, the method comprising:
(a) converting the input melody to an input melody skeleton;
(b) comparing the input melody skeleton with the melody skeleton of each of the plurality of melodies to determine a stored melody of the plurality of melodies that matches the input melody.

The conversion of the input melody to the input melody skeleton may be by:
(a) converting the input melody to a pitch-time series;
(b) approximating the pitch-time series to a sequence of line segments in a time domain;
(c) mapping the sequence of line segments in the time domain into a sequence of points in a value-run domain; and
(d) using extreme points in the sequence of points to form the input melody skeleton.

Each of the melody skeletons of the plurality of stored melodies may be formed by:
(a) converting the stored melody to a pitch-time series;
(b) approximating the pitch-time series to a sequence of line segments in a time domain;
(c) mapping the sequence of line segments in the time domain into a sequence of points in a value-run domain; and
(d) using extreme points in the sequence of points to form the melody skeleton.

Pitch values may be measured as relative pitch, in semitones.

In step (a), a non-pitch part may be replaced by an immediately previous pitch value.

Non-extreme points in the sequence of points are not considered in the matching process.

### BRIEF DESCRIPTIONS OF THE DRAWINGS

In order that the invention may be readily understood and put into practical effect there shall now be described by way of non-limitative example only preferred embodiments of the present invention, the description being with reference to the accompanying illustrative drawings, in which:

FIG. 1 illustrates the architecture of a music retrieval system;

FIG. 2 illustrates the procedure for melody file processing;

FIG. 3 illustrates the procedure for melody query processing;

FIG. 4 illustrates the procedure for melody matching;

FIG. 5 illustrates melody represented by pitch value time series;

FIG. 6 illustrates melody represented by line segments;

FIG. 7 illustrates melody represented by data point sequence in value run domain;

FIG. 8 illustrates an alignment of two data point sequences;

FIG. 9 illustrates the most possible case of errors of extreme points;

FIG. 10 illustrates another four cases of errors in extreme points;

FIG. 11 illustrates the table for computing the distance between two data point sequences q[i] and t[i];

FIG. 12 illustrates the possible previous cells for (i,j) in melody skeleton matching;

FIG. 13 illustrates the mapping of data points in the final melody similarity measure;

FIG. 14 illustrates the dynamic programming table for aligning non-skeleton points in the final melody similarity measure; and

FIG. 15 illustrates six hummed queries of a same tune “Happy Birthday To You” using different tempos by different persons.

### DETAILED DESCRIPTION OF PREFERRED EMBODIMENTS

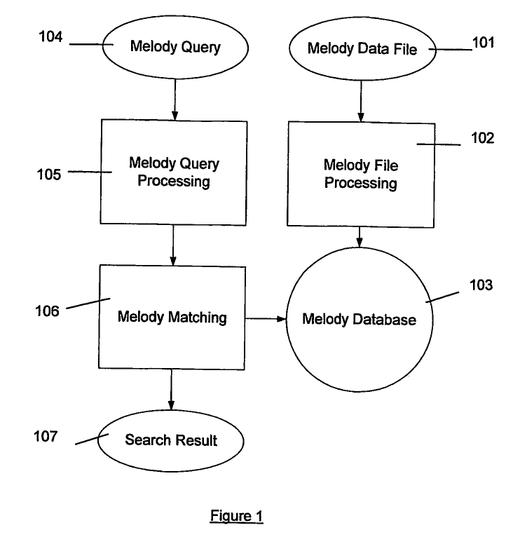

Throughout this specification all reference numerals commence with a prefix figure that denotes the Figure number. For example: 101 is element 1 on FIG. 1. Like components or process steps have like reference numerals.

FIG. 1 illustrates the architecture of a music retrieval system. Melody data files (101) will undergo melody file processing (102) and then be inserted together with melody features into a melody database (103). Melody data files are data files encoding the melody of a music art piece in the form of music notes. One example of a melody data file is a Musical Instrument Digital Interface (“MIDI”) file. A melody query (104) will undergo melody query processing (105), and a melody search engine will then search (106) for melodies in the database (103) that are similar to the melody query (104). A melody query is a part of a melody in the form of acoustic signals that are used for comparison with melodies in a database. The search result (107) is output

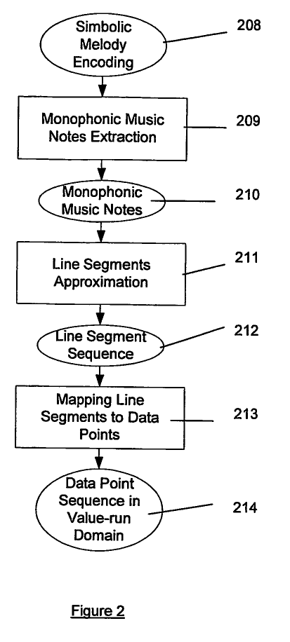

FIG. 2 illustrates the melody file processing procedure 102 of FIG. 1. The input is the melody data file (208), such as a MIDI file, which contains the encoding of music notes. The monophonic melody notes (210) are then extracted (209) from the melody data file and are translated to a line segment sequence (211) based on the pitch values of the music notes. The line segment sequence (212) is mapped (213) to a data point sequence (214), which is in the value-run domain. The data point sequence (214) in value-run domain is the final representation and is stored in the database (103) for the comparison (106) with melody queries (104).

Mapping of a line segment sequence to points in the value-run domain may be by denoting a line segment sequence by (sv[i], sl[i]), where i is the sequence index (1<i<N), sv[i] is the value of the i^{th} line segment and sl[i] is the length of the i^{th} line segment, and N is the number of line segments in the sequence. Each line segment (sv[i], sl[i]) is mapped to a point (v[i], R[1,i]) in the value run domain, where v[i] is still the sequence value sv[i] and R[1,i] is the value-run of sv[i] from the first line segment to the i^{th} line segment.

Given a real valued data sequence v[i], where i is the sequence index, the value-run from the j^{th} value to the k^{th} value R[j,k]:

$$\begin{matrix}R [ j , k ] = {\sum }_{i = j + 1}^{k} \vert v [ i ] - v [ i - 1 ] \vert , & if k > j \\ R [ j , k ] = 0 , & if k = j\end{matrix}$$

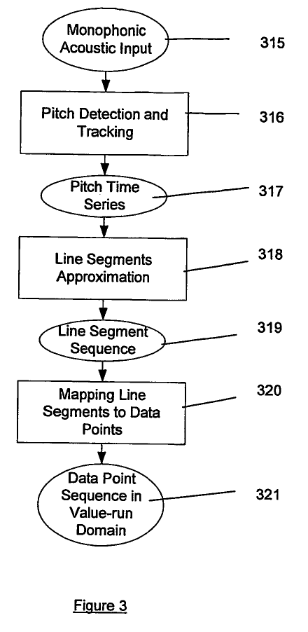

FIG. 3 illustrates the melody query processing procedure (104). The acoustic query input (315) is produced and captured by a microphone. A pitch detection and tracking module finds the pitch values in the input (316), and generates a pitch value time series (317). The pitch value time series (317) is then translated (318) to a line segment sequence (319) by a line segment approximation module. The line segment sequence is then mapped (320) to a data point sequence by a mapping module, which is the same as the mapping for melody (321) file processing (214). The data point sequence of the querying melody will be compared with the data point sequences (214) in the database (103) for music retrieval using the melody search engine.

An extreme point/line segment may be considered as being a local maximum or minimum point /line segment in a point/line segment sequence. The other points/segments are non-extreme points/line segments.

The extreme points in the data sequence for a melody may be used to create a melody skeleton, the melody skeleton being the extreme points in the data sequence for the melody.

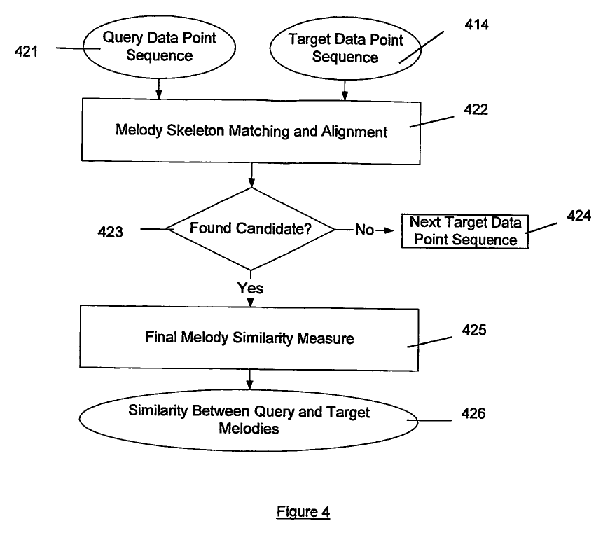

FIG. 4 illustrates the melody similarity matching procedure (106) between a query melody (104) and a target melody (101) in the database (103). The matching takes two steps and the query data point sequence 421 and target data point sequence 214 are used. The first step is the melody skeleton matching (423), which is based on the skeleton points of the data point sequences 421, 414. If the matching cannot find any possible candidates (423) in the target melody data point sequence, the current target melody is skipped and the matching is done for the next target melody (424). If a candidate is found at step 423, then a final detailed melody similarity is conducted (425) in the second step, and the similarity value is output (426) for a ranking.

FIG. 5 shows two graphs illustrating a time series for a hummed query. In FIG. 5(a) pitch values are measured in semitones. The absolute value of pitch is arbitrary and not important because it is only the relative pitch that is of concern. Therefore, pitch values are relative to the lowest pitch in the hummed query. The zero value in the plot stands for non-pitch (silence). FIG. 5(b) illustrates the time series transcribed from the musical notes of a melody. The non-pitch part is replaced by the previous pitch value in order to avoid gaps in the plot. The melody concerned in FIG. 5 is “Auld Lang Syne”.

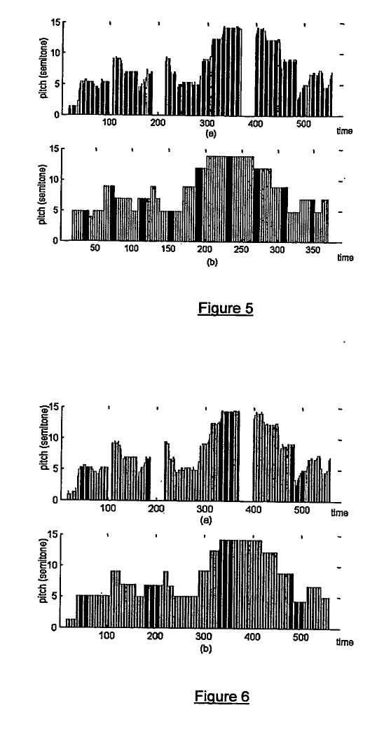

FIG. 6 again shows two graphs—the first (a) being the same time series in FIG. 5(a). Graph (b) show the line segments approximating the time series shown in (a). In FIG. 6(b) the gaps (non-pitch frames) in 6(a) are padded to provide line segments approximating the query time series of (a).

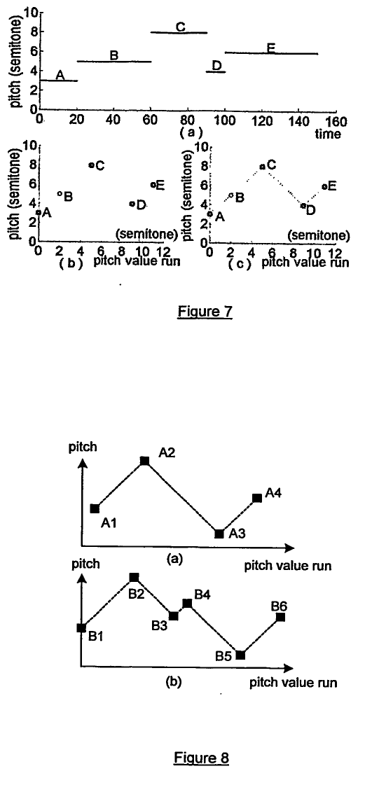

FIG. 7 has three graphs with (a) showing a line segment sequence [(3,20), (5,40), (8,30), (4,10), (6,50)] in time domain, (b) showing the corresponding data sequence in value-run domain [(0,3), (2,5), (5,8), (9,4), (11,6)], and 3(c) showing the points connected by dotted straight lines. In (b) and (c) the solid square points (A, C, D, and E) correspond to local maximum (peak) and minimum (valley) line segment in (a), and the hollow circle point (B) corresponds to the non-extreme line segment, the line segment B in (a).

FIG. 8 contains two graphs (a) and (b) that illustrate two melody skeleton sequences. A good mapping between the two sequences is [(A1,B1), (A2,B2), (A3,B5), (A4,B6)]. In this mapping two points in (b)—B3 and B4—are not mapped to any points in (a), to accommodate the possible errors.

The melody skeleton matching serves two roles. First, it locates only the likely candidates who have a skeleton similar to that of the query melody. Secondly it provides a proper alignment between the query data sequence and the candidate data subsequence. The first function is to filter out all incorrect candidates using a relatively small number of steps. The second function is to help conduct a detailed similarity measure match.

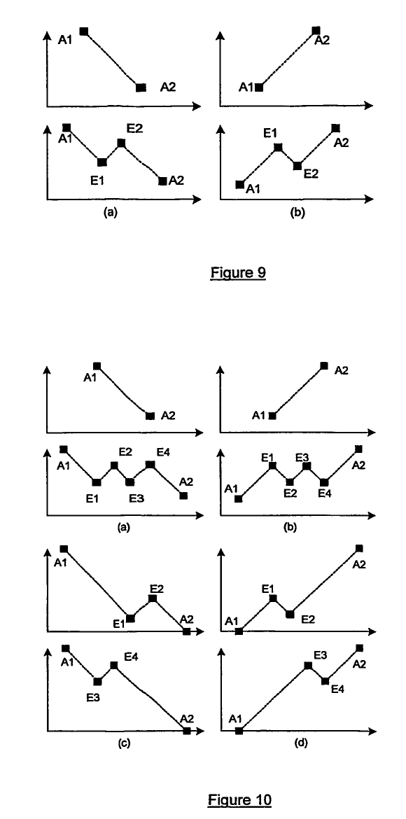

FIG. 9 shows two most probable cause of errors in matching extreme points. There are two graphs for both (a) and (b). The upper graph is of that in the database, and the lower graph is of that from a query. Graphs (a) show the case where the pitch is descending, and in graphs (b) the pitch is ascending. In both (a) and (b), the points E1 and E2 should be skipped in the matching. These two points are either incorrectly introduced or wrongly omitted in a query. Usually the two points E1 and E2 have a small pitch difference, since only small pitch level disturbance is likely to be introduced or omitted.

FIG. 10 is similar to FIG. 9 and illustrates some less likely causes of errors of extreme points. In these cases, (a)(b)(c)(d), four points E1, E2, E3, and E4 are skipped from mapping. The cause of the errors is the same as the previous cases. Note that all the extreme points of errors are preferably presented in pairs, such as (E1, E2) and (E3, E4). Other cases of errors of the extreme points may be considered when necessary.

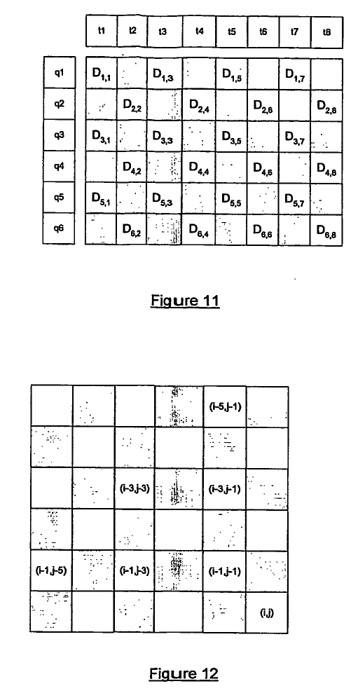

FIG. 11 illustrates a table for the melody skeleton matching (422). A query data sequence is denoted as q[i], where 1<i<m, i is the index of the sequence, and m is the number of points in the sequence. The pitch value and value run of q[i] are denoted as qv[i] and qr[i]. A target data sequence is denoted as t[i], where 1<i<n, i is the index of the sequence, and n is the number of points in the sequence. The pitch value and value run of t[i] are denoted as tv[i] and tr[i]. For simplicity, assume n>m, and q[1] and t[1] are both peak points, or both valley points. The table is for calculating the distance between two sequences starting from q[1] and t[1]. A value of a cell in the table D_{i,j} stands for the minimum accumulated distance of (q[1], . . . ,q[i]) to (t[1], . . . ,t[j]). Since a peak point does not match with a valley point, the distance values of the shaded cells in the table are not computed. There are two issues of concern:
(1) computing the distance value in a cell; and
(2) tracing the path of an alignment that has the minimum distance. By using the accumulated distance for each cell (i,j) means D_{i,j} equals a local distance added by the distance value D_{x,y} of a “previous” cell (x,y).

FIG. 12 illustrates possible “previous” cells of (i,j) depending on the possible cases of point skipping shown in FIGS. 9 and 10. If the cell (i−1, j−1) is the previous cell, then it means there is no point skipping for D_{i,j}. If (i−1, j−3) or (i−3,j−1) is the previous cell, then there is a 2-point-skipping, as in the case shown in FIG. 9. If (i−1, j−5) or (i−5,j−1) is the previous cell, then there is a 4-point-skipping as in the case shown in FIGS. 10(a) and 10(b). If (i−3,j−3) is the previous cell, then there is a 4-point-skipping as in the case shown in FIGS. 10(c) and (d). Other possibilities of previous point for (i,j) may be considered when necessary.

With the possible previous cells for (i,j) given, the distance value for D_{i,j} can then be determined.

$${D}_{i , j} = {d}_{base} ( i , j ) + min \{ \begin{matrix}{D}_{i - 1 , j - 1} \\ {D}_{i - 1 , j - 3} + P ( i , - 1 , j , - 3 ) \\ {D}_{i - 3 , j - 1} + P ( i , - 3 , j , - 1 ) \\ {D}_{i - 1 , j - 5} + P ( i , - 1 , j , - 5 ) \\ {D}_{i - 5 , j - 1} + P ( i , - 5 , j , - 1 ) \\ {D}_{i - 3 , j - 3} + P ( i , - 3 , j , - 3 )\end{matrix} \qquad ( 1 )$$

where i>3 or i>5 or j>3 or j>5 are required for the respective case to be considered.

$$\begin{matrix}{d}_{base} ( i , j ) = \vert qv ( i ) - tv ( j ) - λ \vert & ( 2 ) \\ λ = qv ( 1 ) - tv ( 1 ) & ( 3 ) \\ P ( i , - k , j , - l ) = {P}_{Q} ( i , k ) + {P}_{T} ( j , l ) & ( 4 ) \\ {P}_{Q} ( i , k ) = 0 , if k = 1 & ( 5 ) \\ {P}_{Q} ( i , k ) = η {\sum }_{x = 1}^{( k - 1 ) / 2} \vert qv ( i - 2 x + 1 ) - qv ( i - 2 x ) \vert & ( 6 ) \\ {P}_{T} ( j , l ) = 0 , if l = 1 & ( 7 ) \\ {P}_{T} ( j , l ) = η {\sum }_{x = 1}^{( l - 1 ) / 2} \vert tv ( j - 2 x + 1 ) - tv ( j - 2 x ) \vert & ( 8 )\end{matrix}$$

d_{base}(i,j) is the local distance between q[i] and t[j], and λ is the shifting between q[1] and t[1]. P(i,−k,j,−l) is the penalty imposed for point skipping, in which P_{Q}(i,k) is the penalty for skipping points in query, and P_{T} is the penalty for skipping points in target The penalty is based on the sum of the value differences of the pairs of points that are skipped. η is a weight for the penalties.

The previous cell, which gives (i,j) the minimum distance value, is chosen and recorded. Another table, which looks like the table shown in FIG. 11, is used for this. The cells of the table store the pointers to (or the index of) the respective chosen previous cells.

The border cells are initialized as:
D_{1,1}=0;
D_{1,j}=∞; for j>1
D_{i,1}=∞; for i>1
   since the alignment starts with q[1] and t[1].

The order of determination of distance values for other cells is from top to bottom, and from left to right. Since the possible previous cells and the border initialization are known, not all the cells in the table need to be determined because distance values of some cells are determined to be ∞. Furthermore, the value-run can also be used to constrain the number of cells to be determined. For alignment, the mapped points from query sequence and target sequence preferably should not have a large difference in their value run after shifting the run difference between q[1] and t[1].

After the determination of distance value of the cells, the best alignment is obtained by locating the

$${D}_{m , x} = {min}_{j} {D}_{m , j} ,$$

which means (q[1], . . . ,q[m]) has the minimum accumulated distance with (t[1], . . . ,t[x]), and D_{m,x} is the distance value.

The mapped path is obtained by tracing back from the cell (m,x) in the path table. The tracing is stopped when the pointer points to cell (1,1).

This may find the best subsequence of target sequence starting from t[1], which can be aligned with the query sequence (q[1], . . . ,q[m]). For the other subsequence in the targeting sequence starting from t[1+2x] (x>0), the determination may be performed in a similar manner by replacing t[1] by t[1+2x].

For each starting position (2x−1) (0<x<n/2+1) in the target sequence, the best alignment with the query sequence is found and the corresponding accumulated distance Dₘ(x) is obtained. In these n/2 alignments, the alignments at the following position are selected as matches with the query sequence based on Dₘ(x):
Dₘ(x) is a local minimum;
Dₘ(x)<Dₜₕᵣₑₛ.

The local minimum of Dₘ(x) is selected as the best alignment preferably always has a smaller distance than the alignment at adjacent positions. Dₜₕᵣₑₛ is a threshold, which is to ensure that the aligned target subsequence is close enough to the query sequence. The selected target subsequences are likely candidates, on which an accurate final melody similarity will be determined.

FIG. 13 illustrates data point mapping in the final melody similarity measure (425). In the mapping process all the data points of the two sequences, including the non-extreme points. The alignment of all the data points in two data sequences is based on the alignment of the extreme points of the two sequences, or melody skeleton matching. This step only aligns the non-extreme points and skipped extreme points between two not-skipped extreme points in a sequence with the non-extreme points or skipped extreme points between corresponding mapped extreme points in the other sequence. The hollow round points represent non-extreme points, hollow square points denote extreme points that are skipped in the extreme point alignment, and the solid square points are the extreme points that are mapped in the extreme point alignment process. The solid line stands for mapping of extreme points (described above in relation to FIGS. 11 and 12), and the dashed line stands for the mapping of non-extreme points or skipped extreme points, which is in this step. The mapped extreme points are the skeleton points, and the non-extreme points and not-mapped extreme points are the non-skeleton points.

The mapping of non-skeleton points, requires the following:
(1) shifting of the value of the two sequence based on the aligned skeleton points; and
(2) mapping of the non-skeleton points.

In the alignment of skeleton points, the value shifting of two sequences is based on the first point of the respective sequence. This shifting value may be biased towards the beginning points, so the shifting value is redetermined based on all the skeleton points. By denoting the pitch values of the skeleton points in the query sequence and target subsequence by qvₛₖ(i) and tvₛₖ(i), 0<i<=L, the new shifting value is given by:

$$λ = ( {\sum }_{i = 1}^{L} {qv}_{sk} ( i ) - {tv}_{sk} ( i ) ) / L \qquad ( 9 )$$

This new shifting value will be used in the mapping of the non-skeleton points. Assume a skeleton point q(a) in the query sequence is mapped with the skeleton point t(b) in the target subsequence. The pair of skeleton points following these two points are q(a+x) and t(b+y) respectively. So the points q(a+1), . . . ,q(a+x−1) are the non-skeleton points in the query sequence, and points t(b+1), . . . ,t(b+y−1) are the non-skeleton points in targeting sequence.

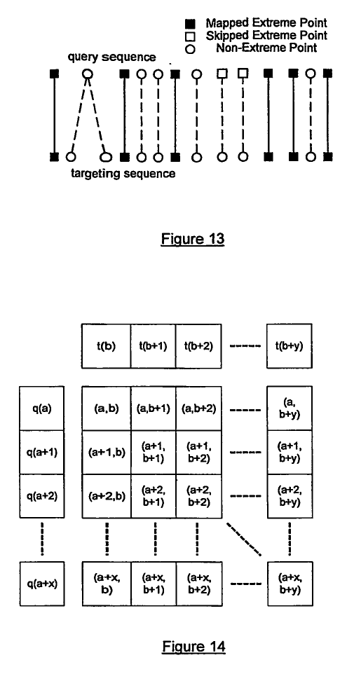

FIG. 14 illustrates a process for the alignment of non-skeleton points.

For each cell (i,j) in the table, a local distance value d(i,j) is calculated using the following equations:

d(i,j)=|qv(i)−tv(j)−λ| (10)

where λ is given by equation 9 above.

The mapping of the non-skeleton points is obtained by tracing a path in the table from (a,b) to (a+x,b+y), which has the minimum accumulated distance.

In this way, any non-skeleton point can be aligned by using its leading skeleton point and its following skeleton point Finally, all points in the query sequence are mapped to the points in the target sequence. And the similarity measure between the two sequences can now be computed based on the mapping.

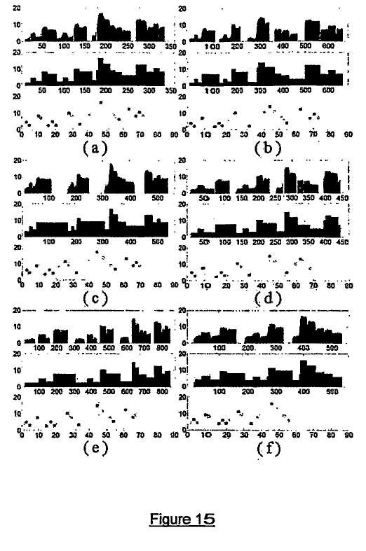

FIG. 15 shows six hummed queries of the tune “Happy Birthday To You” using different tempos by different subjects. FIG. 15(d) shows the query hummed in normal speed. FIG. 15(a) shows a faster tempo. FIGS. 15(e) and (f) shows slower tempos. FIGS. 15(b) and (c) shows inconsistent tempos. Each figure in FIG. 15 shows the original query time series, line segments approximation, and the value-run domain data points. It can be seen that the melody skeleton structure formed by extreme points is almost identical for all the six queries.

The present invention also encompasses a computer usable medium comprising a computer program code that is configured to cause at least one processor to execute one or more functions to perform the above method.

Whilst there has been described in the foregoing description preferred embodiments of the present invention, it will be understood by those skilled in the technology that many variations or modifications in details of design, construction and methodology may be made without departing from the present invention.

1. A method for melody representation comprising:
(a) converting a melody to a pitch-time series;
(b) approximating the pitch-time series to a sequence of line segments in a time domain; and
(c) mapping the sequence of line segments in time domain into a sequence of points in a value-run domain.

2. A method as claimed in claim 1, wherein pitch values are measured as relative pitch, in semitones.

3. A method as claimed in claim 1, wherein in step (a) a non-pitch part is replaced by an immediately previous pitch value.

4. A method as claimed in claim 1, wherein the melody is input as an analog audio signal.

5. A method as claimed in claim 1, wherein the result of step (c) is used to produce a melody skeleton, the melody skeleton comprising extreme points in the sequence of points.

6. A method as claimed in claim 1, wherein the result of step (c) is invariant to a tempo of the melody.

7. A method for creating a database of a plurality of melodies, the method comprising, for each of the plurality of melodies:
(a) converting the melody to a pitch-time series;
(b) approximately the pitch-time series to a sequence of line segments in a time domain;
(c) mapping the sequence of line segments in time domain into a sequence of points in a value-run domain; and
(d) storing the sequence of points in the value run domain in the database.

8. A method as claimed in claim 7, wherein pitch values are measured as relative pitch, in semitones.

9. A method as claimed in claim 7, wherein in step (a) a non-pitch part is replaced by an immediately previous pitch value.

10. A method as claimed in claim 7, wherein the melody is input as an analog audio signal.

11. A method as claimed in claim 7, wherein the result of step (c) is used to produce a melody skeleton, the melody skeleton comprising extreme points in the sequence of points.

12. A method as claimed in claim 7, wherein the result of step (c) is invariant to a tempo of the melody.

13. A method for raising a query to compare an input melody with a plurality of melodies each stored in a database as a stored sequence of points in a value-run domain, the method comprising:
(a) converting the input melody to a pitch-time series;
(b) approximating the pitch-time series to a sequence of line segments in a time domain;
(c) mapping the sequence of line segments in the time domain into a sequence of points in a value-run domain; and
(d) comparing the sequence of points in the value-run domain for the input melody with each of the stored sequence of points for each of the plurality of melodies to determine a stored melody of the plurality of melodies that matches the input melody.

14. A method as claimed in claim 13, wherein the sequence of points in the value-run domain for the input melody are used to create an input melody skeleton.

15. A method as claimed in claim 14, wherein the input melody skeleton comprises extreme points in the sequence of points.

16. A method as claimed in claim 13, wherein the input melody is input as an analog audio signal.

17. A method as claimed in claim 13, wherein pitch values are measured as relative pitch, in semitones.

18. A method as claimed in claim 13, wherein in step (a) a non-pitch part is replaced by an immediately previous pitch value.

19. A method as claimed in claim 18, wherein the melody is input as an analog audio signal.

20. A method as claimed in claim 19, wherein the result of step (c) is used to produce a melody skeleton, the melody skeleton comprising extreme points in the sequence of points.

21. A method as claimed in claim 13, wherein the result of step (c) is invariant to a tempo of the melody.

22. A method as claimed in claim 20, wherein matching is by sequentially comparing the melody skeleton with the stored melody skeleton until a match is found.

23. A method as claimed in claim 22, wherein non-extreme points in the sequence of points are not considered in the matching process.

24. Apparatus for enabling the raising of an input melody query of a plurality of stored data point sequences melodies in a database, the apparatus comprising;
(a) a microphone for creating an input analog audio signal of the input melody;
(b) a pitch detecting a tracking module for determining pitch values in the input analog audio signal and generating a pitch value time series;
(c) a line segment approximation module for approximating the pitch value time series to a line segment series;
(d) a mapping module for mapping line segment series to a data point sequence; and
(e) a melody search engine to perform a melody similarity matching procedure between the input melody data point sequence and each of the plurality of stored data point sequences in the database.

25. Computer usable medium comprising a computer program code that is configured to cause at least one processor to execute on or more functions for raising a query to compare an input melody with a plurality of melodies each stored in a database as a stored sequence of points in a value-run domain by:
(a) converting the input melody to a pitch-time series;
(b) approximating the pitch-time series to a sequence of line segments in a time domain;
(c) mapping the sequence of line segments in the time domain into a sequence of points in a value-run domain; and
(d) comparing the sequence of points in the value-run domain for the input melody with each of the stored sequence of points in the value run domain of the plurality of melodies to determine a stored melody of the plurality of melodies that matches the input melody.

26. A method for raising a query to compare an input melody with a plurality of melodies each stored in a database and stored as a melody skeleton, the method comprising:
(a) converting the input melody to an input melody skeleton;
(b) comparing the input melody skeleton with the melody skeleton of each of the plurality of melodies to determine a stored melody of the plurality of melodies that matches the input melody.

27. A method as claimed in claim 26, wherein the conversion of the input melody to the input melody skeleton is by:
(a) converting the input melody to a pitch-time series;
(b) approximating the pitch-time series to a sequence of line segments in a time domain;
(c) mapping the sequence of line segments in the time domain into a sequence of points in a value-run domain; and
(d) using extreme points in the sequence of points to form the input melody skeleton.

28. A method as claimed in claim 26, wherein each of the melody skeletons of the plurality of stored melodies is formed by:
(a) converting the stored melody to a pitch-time series;
(b) approximating the pitch-time series to a sequence of line segments in a time domain;
(c) mapping the sequence of line segments in the time domain into a sequence of points in a value-run domain; and
(d) using extreme points in the sequence of points to form the melody skeleton.

29. A method as claimed in claim 27, wherein pitch values are measured as relative pitch, in semitones; and in step (a) a non-pitch part is replaced by an immediately previous pitch value.

30. A method as claimed in claim 28, wherein in step (a) a non-pitch part is replaced by an immediately previous pitch value; and pitch values are measured as relative pitch, in semitones

31. A method as claimed in claim 27, wherein non-extreme points in the sequence of points are not considered in the matching process.

32. A method as claimed in claim 28, wherein non-extreme points in the sequence of points are not considered in the matching process.
